(19) United States
(12) Patent Application Publication
(10) Pub. No.: US 2007/0084515 A1
(43) Pub. Date: Apr. 19, 2007

(54) Method and apparatus for proportional mixing of cleaning compositions

(76) Inventor: Timothy P. Kimsey, Independence, MO (US)

Correspondence Address: HOVEY WILLIAMS LLP, 2405 GRAND BLVD., SUITE 400, KANSAS CITY, MO, 64108, US

(21) Appl. No.: 11/249,862

(22) Filed: Oct. 13, 2005

(51) Int. Cl. F16K 11/00

(52) U.S. Cl. 137/890

(57) ABSTRACT

An apparatus and a method for in-line proportional mixing of chemical cleaning compositions includes first and second venturi provided in sequence for receiving respective cleaning compositions and drawing the compositions into a flow path. A float actuated valve is provided upstream from at least the first venturi. A pressure regulator is provided for controlling the pressure of water reaching the venturi to provide more precise control over the proportioning of the cleaning compositions through the venturi.

### BACKGROUND OF THE INVENTION

1. Field of the Invention

A method and apparatus for proportional mixing of cleaning compositions is provided which enables two cleaning compositions to be introduced in sequence into a flowing stream of liquid without the use of local pumping apparatus. More particularly, it provides a simplified system whereby the cleaning compositions maybe accurately sequentially metered, and without requiring a complete pressure drop inline where one of the compositions is introduced into the flow.

2. Description of the Prior Art

In order to avoid the costs of transporting mixed chemical compositions where a large portion of the composition is water, such compositions are typically provided in concentrated form. Such cleaning compositions are often provided as concentrated liquid solutions, for example detergents, while other compositions such as akaline cleaners may be provided as powders. To provide a satisfactory cleaning solution, oftentimes two such compositions must be mixed with water in desired ratios prior to use. While such compositions may be introduced into water in batch increments, such as in an ordinary household dishwasher, large commercial cleaning operations such as self-service or automated car washes have intermittent demands and the addition of labor to periodically introduce chemicals into batch mixing operations is a tedious task which cannot be justified in terms of need and cost.

As a result, a need has developed for a system whereby chemicals can be introduced to provide cleaning compositions on a readily available, continuous basis. Systems for mixing chemicals to provide cleaning compositions are shown, for example, in U.S. Pat. No. 5,439,020 and in U.S. Pat. No. 5,678,593, the disclosures of which are incorporated herein by reference. In each of these patents, a powdered detergent is introduced into water in a dissolution tank, and then delivered to one or more mixing tank provided with a float valve of the type commonly sold under the trademark Hydrominder. A manifold is provided on the Hydrominder float valve in the system shown in the U.S. Pat. No. 5,439,020 patent whereby a plurality of different liquid detergent concentrates, foamers, or other additives can be introduced from the manifold by the use of a venturi into the flow of liquid flowing from the Hydrominder float valve and then deposited at atmospheric pressure into a mixing tank. The U.S. Pat. No. 5,678,593 patent shows a modified system from that shown and described in the U.S. Pat. No. 5,439,020 patent, wherein two or more venturis are positioned for parallel flow upon exiting the Hydrominder float valve.

While the systems described in the U.S. Pat. Nos. 5,439,020 and 5,678,593 patents are useful, a need has developed for a simplified system. In addition, given the expense of the chemical concentrates used in such cleaning system, there is a need for a system which provides more precision in the introduction of chemicals, and inhibits undesired delivery of such compositions or backflow of water into the concentrate containers.

### SUMMARY OF THE INVENTION

These and other objects have largely been met by the method and apparatus for proportional mixing of cleaning compositions hereof. The system hereof provides a simple and elegant system for proportional mixing of chemicals which are available on-demand without the need for complicated pumps or manifolds. Moreover, the method and apparatus for proportional mixing of cleaning compositions hereof may utilize powdered cleaners in solution as well as liquid compositions, is compact and self-contained. and provides accurate delivery of mixed compositions to a holding tank, shutting off delivery when the capacity of the holding tank is reached.

Broadly speaking, the method and apparatus for proportional mixing of cleaning compositions hereof includes a pressure regulating device for limiting the pressure of water entering the apparatus, an injector for delivering a first concentrated composition into the flow of water, a float valve for stopping the flow of water when the level in the holding tank reaches a desired level, and a proportioner for delivering a second flow of liquid concentrated cleaner into the main flow of liquid. The injector is positioned upstream of and not parallel to the proportioner, and in alternate arrangements, the injector can be positioned in the main water flow either upstream of the float valve or downstream therefrom. As used in this application, cleaning compositions, whether powdered or liquid, are not limited to detergents or other surfactant compositions, but may include a variety of scrubbing or cleaning chemicals, and associated chemicals such as anti-spotting agents, waxes, or other compositions used in connection with, for example, self-service or automatic car washes as are well known to those skilled in the art. The main flow of liquid, which is initially a flow of water from a municipal or other water delivery system under pressure, once the concentrated compositions are mixed therewith, is then provided to a holding tank, from which it may be drawn, pumped or otherwise delivered as needed. The method hereof includes the introduction of two discrete concentrated cleaning solutions in series into a main flow of liquid. Preferably, both introductions are accomplished through the use of venturi such that neither concentrated compositions are required to be pumped under positive pressure until after mixing, and in alternate arrangements may occur where one or both venturi, in sequence, may be placed downstream of the float valve, such that one such introduction occurs where there exists at least some backpressure in the flow line while a second introduction occurs downstream of the float valve as the main flow of liquid drops to at or near atmospheric pressure in the course of flow into the holding tank.

The method and apparatus hereof preferably provides for the use of powdered cleaning compositions such as inorganic chemical compositions including alkaline cleaners in a mixing tank for providing a source of one of the cleaning solutions, which are typically provided as concentrates. The powdered cleaner is mixed into a concentrated solution in the mixing tank, then drawn as needed into the main flow by a venturi in the proportioner. A second liquid solution, such as a surfactant in liquid form from a container, is introduced into the flow stream upstream of the proportioner by an injector. The introduction of the cleaning solutions may be controlled with considerable precision by the use of a pressure regulating device for the main water supply into which the concentrated solution is drawn. By regulating the pressure, wide and rapid fluctuations of pressure in the main flow stream are greatly limited, thereby increasing performance of the apparatus. The injector is preferably used to deliver the second liquid solution, that is the surfactant, into the main flow either upstream of or downstream from a float valve. The float valve provides a positive shut-off mechanism to stop the flow of water through the apparatus once the desired maximum level of mixed solution is received in the holding tank. Advantageously, the injector, which includes a venturi, is configured to introduce the second solution into the main flow not withstanding remaining backpressure downstream therefrom. That is to say, the use of the injector avoids a requirement that the pressure drop be 100% to atmospheric pressure in order to function. To avoid backflow or leakage into either or both of the proportioner or injector, a check valve may be provided to ensure that concentrated solution or other liquid only enters the main flow stream, and not vice-versa.

These and other benefits of the present invention will be readily appreciated by those skilled in the art with reference to the specification and drawings showing preferred embodiments of the invention.

### BRIEF DESCRIPTION OF THE DRAWINGS

FIG. 1 is a perspective view of a cleaning composition supply system including an apparatus for proportional mixing of cleaning compositions in accordance with the present invention, showing the mixing tank for receiving a powder composition for providing a concentrated cleaning solution, a holding tank for receiving a mixed cleaning composition with a portion of the tank removed for clarity, and a source of a liquid cleaner for delivering a concentrated liquid cleaner to the proportional mixing apparatus of the present invention;

FIG. 2 is an enlarged perspective view showing the proportional mixing apparatus hereof, showing a pressure regulator, an injector connected to the delivery conduit for the concentrated cleaning solution, a float valve for limiting the flow of mixed cleaning composition, and a proportioner for introducing a concentrated liquid cleaner into the liquid flow from the float valve;

FIG. 3 is a perspective view of an alternate cleaning composition supply system similar to FIG. 1, wherein the proportional mixing apparatus positions the injector adjacent the proportioner; and

FIG. 4 is an enlarged perspective view of the alternate proportional mixing apparatus hereof similar to FIG. 2, wherein the injector is positioned upstream from the proportioner and downstream from the float valve.

### DESCRIPTION OF THE PREFERRED EMBODIMENT

Referring now to the drawing, a cleaning composition supply system 10 is shown and is adapted to receive a flow of water from a water supply 12, for example a municipal water system. The cleaning composition supply system broadly includes a mixing tank 14, a holding tank 16, a source 18 for introducing powdered cleaner into the mixing tank, a proportional mixing apparatus 20 adapted for receiving a flow of a concentrated cleaning solution from the mixing tank and water from the water supply 12, and a container 22 serving as a source for providing concentrated liquid cleaner, preferably a surfactant such as a detergent to the proportional mixing apparatus 20. In addition, a delivery line 24 leads from the holding tank 16 and is typically provided with pump P for pumping cleaning solution from the holding tank 16 for use. Such use may be, for example, a laundry or dishwashing application, but more preferably for use in a self-service or automated car wash having a plurality of bays which having individual spray wands for the application of different liquids to a vehicle to be cleaned.

In greater detail, the mixing tank 14 receives the water from the water supply 12 through pipe 26, which may be provided with a valve V for controlling the delivery of water to the mixing tank 14, while primary water pipe 28 delivers water under pressure to the proportional mixing apparatus 20. While it is contemplated that the valve V would be a manually operated valve when batch mixing is to be performed in the mixing tank 14, an automated valve such as a float valve of the type described hereinafter could be used if the delivery of the powdered cleaner to the mixing tank 14 is regulated based on the delivery of water into the tank. The valve V may also be or include an anti-siphoning or vacuum breaker valve to prevent the siphoning of liquid from the mixing tank 14 back into the water supply 12. The source 18 for the powdered cleaner may be a hopper, scoop, or funnel 30 as shown mounted on the mixing tank 14 and serving as a directing mechanism for receiving and delivering an alkaline cleaning composition, preferably but not necessarily in powdered form, to the mixing tank 14. A suitable alkaline cleaning composition for this use would include, for example, trisodium phosphate. A stirrer 32 is provided which may powered by a motor as shown, or the stirrer may be operated manually, if desired, but in either event serves to dissolve the powered cleaner delivered from the funnel 30 and keep it in solution. It may be appreciated that the powdered cleaner could be introduced from any source, such as a bag or bucket for manual delivery, or an automated metering hopper if desired for automated delivery, and that water could be introduced on an automated basis to fill the mixing tank 14 by use of a variety of devices, such as a timing and metering device, for example a BatchMaster timer and valve available as Part No. KT-101 from Kim Supply, Inc. of Kansas City, Mo. Moreover, the stirrer 32 could be a simple paddle used to periodically stir the concentrated cleaning solution in the mixing tank 14 in simple batch operations. Whether provided as an automated feed and mixing station or as a simple manual batch tank as described above, or some combination in-between, the sole purpose of the mixing tank 14 is to provide a reservoir as a source for the first cleaning composition to be supplied to the proportional mixing tank 20. Thus, when the powdered cleaner is at least partially dissolved in the mixing tank 14, a concentrated cleaning solution is then held in the mixing tank 14. A concentrate conduit 34 may be provided with a strainer 36 at the entry end and leads to the proportional mixing apparatus 20 as described hereinafter.

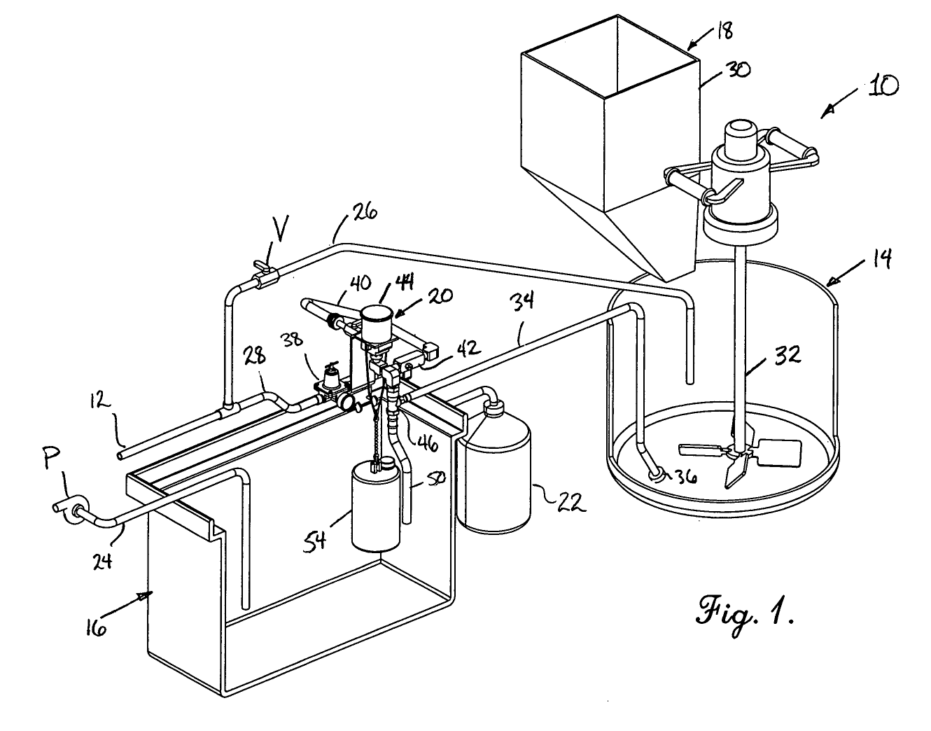

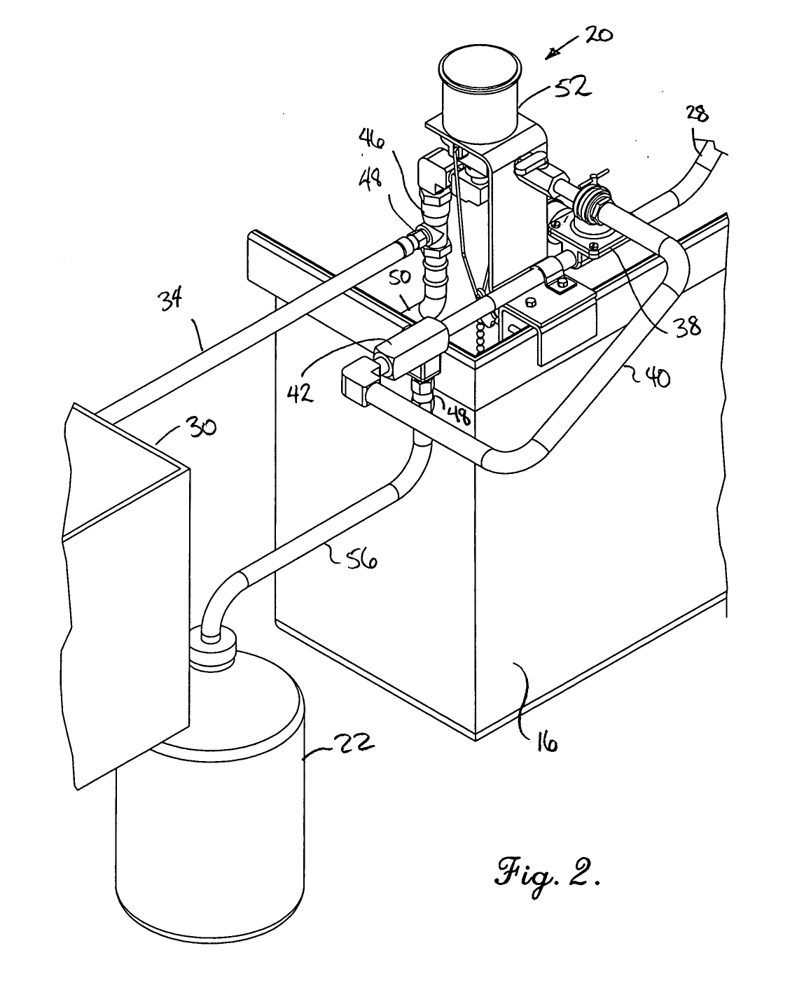

The holding tank 16 is fluidically connected to the mixing tank 14 by the concentrate conduit 34, via the proportional mixing apparatus 20. The proportional mixing apparatus 20 as shown in FIGS. 1 and 2 includes a pressure reducer 38, a connecting conduit 40, an injector 42, a float-actuated control valve 44 and a proportioner 46. Suitable pressure reducers 38 include both pressure reducing valves and flow restrictors preferably operating over a wide pressure range, such as 20 psi to 80 psi and include, but are not limited to, an SMC flow restrictor part no. 693-6F6F-E available from Kim Supply, Inc. of Kansas City, Mo. a fixed 30 psi pressure reducing valve from Dema Engineering of St. Louis, Mo. or a Watts Adjustable Pressure Reducing Valve such as that provided as part no. KV026 from Kim Supply, Inc. of Kansas City, Mo. with a pressure range of between 5 psi and 50 psi and most preferably set at 30 psi and a maximum flow rate of 5 gallons per minute. The pressure reducer 38 serves to reduce a variable inlet pressure of the water entering from the primary water pipe 28 to a lower, less variable pressure. The use of a pressure reducer 38 beneficially provides a substantially constant inlet pressure to the injector 42 under normal operating conditions, thereby promoting accurate delivery of the concentrated cleaning solution from the delivery conduit 34 through the inj ector 42, and also so that variations in pressure and volume through the float actuated control valve 44 and proportioner 46 can be eliminated or reduced, again promoting accuracy of delivery of the liquid chemical. Water from the primary water supply 12 enters the pressure reducer 38 from the primary water pipe 28 and then travels through connecting conduit 40 to enter injector 42.

The injector 42 includes a venturi whereby water flowing from the connecting conduit 40 draws liquid cleaner from the container 22 under the Bernoulli principle. A characteristic of an injector 42, in contrast to a proportioner 46, is that it functions to draw the concentrated cleaning solution into the inj ector 42 for downstream delivery notwithstanding the existence of pressure above atmospheric downstream. Thus, a pressure drop of 35% or more across the injector 42 will still be sufficient to draw the liquid cleaner from the container 22 into the flow of water received from the water supply 12. One suitable injector 42 useful in accordance with the present invention is an adjustable orifice injector available as part number 203C from Dema Engineering Co. of St. Louis, Mo. Such an injector preferably includes a check valve to inhibit backflow or leakage into the container 22, but an additional check valve 48 may be provided as a backup or fail-safe measure. Though not limited to this example, a suitable check valve 48 for this application is a foot check valve which includes a strainer available from Kim Supply, Inc. of Kansas or any other suitable check valve which opens at a sufficient pressure, such as 5 psi or greater. Such a check valve helps to prevent the flow of cleaning compositions or water from the injector down through a tube 56 into the container 22.

The float actuated control valve 44 is operative to terminate the flow of liquid and includes a main body 52and a float 54 connected by a chain to the main body 52. The when the level of the mixed cleaner in the holding tank falls below a predetermined desired level, as determined by the selected length of the chain, the float 54 exerts a force on the main body 52 to open an internal valve and permit liquid to flow through the main body 52, while when the liquid level rises sufficiently, the float actuated control valve shuts off the liquid flow through the valve 44. While a variety of different float actuated control valves 44 are useful in connection with the present invention, suitable float valves include a range of valves sold under the trademark Hydrominder (including Hydrominder Models 506 and 511) available from Hydro Systems Company of Cincinnati, Ohio and Dema Engineering magnetically operated float valves available as part no. 440N from Kim Supply, Inc. A proportioner 46 is located downstream from the float actuated control valve 44. A proportioner 46, like injector 42, includes a venturi and operates on the Bernoulli principle. However, the proportioner operates with a pressure drop of 100% to substantially atmospheric pressure between the inlet and outlet ends thereof. Such a proportioner is typically sold as a component of the Hydrominder float valves and may also be purchased separately as liquid level proportioner from Dema Engineering. Thus, the proportioner is positioned within the flow stream of the proportional mixing apparatus hereof in series with the injector and downstream therefrom. The proportioner 46 is connected to the mixing tank 14 by delivery conduit 34 so that concentrated cleaning solution from the mixing tank 14 may be drawn into the proportioner, mixed into the flow stream at a predetermined rate as determined by the metering tip selected with the proportioner, and delivered to the holding tank 16. As with the injector 42, the proportioner 46 may be provided with a check valve 48 positioned between the container 22 and the proportioner 46 to eliminate or limit the flow of water and concentrated cleaning solution into the container 22. A drop tube 50 leads from the proportioner 56 to the holding tank 16 to deliver mixed cleaning composition thereto.

Delivery line 24 leads from the holding tank 16 to provide the mixed cleaning compositions mixed with water for further use. Delivery of the mixed cleaning composition is typically aided by a pump P which can suitably draw and then pressurize the liquid from the holding tank 16 to a cleaning wand, receptacle or the like for later use.

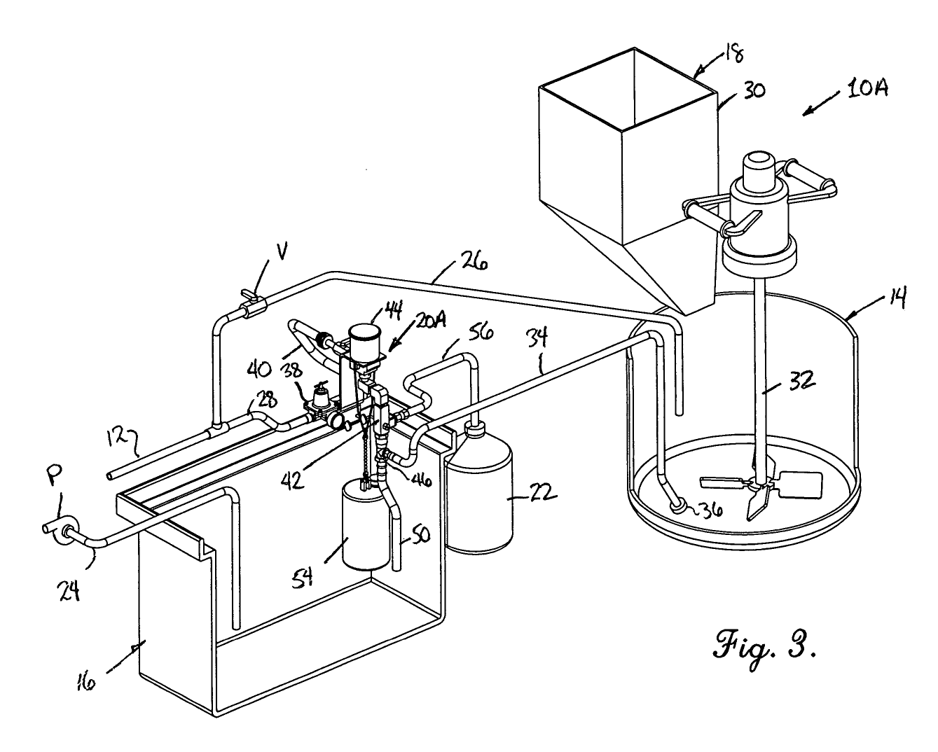

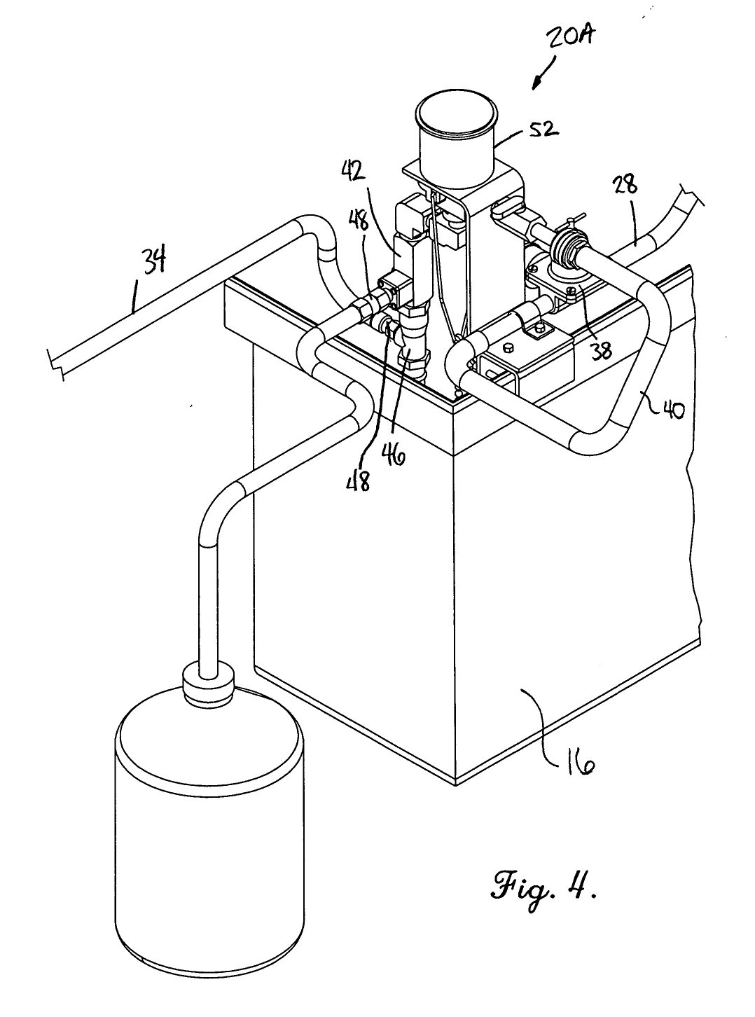

FIGS. 3 and 4 show an alternate arrangement of the cleaning composition supply system 10A and proportional mixing apparatus 20A which is similar to the supply system 10 and proportional mixing apparatus 20 except in one respect. In the proportional mixing apparatus 20A, the injector 42 is positioned downstream from the float valve 44 while remaining upstream from and in series with the proportioner 46. Thus, water delivered from the water supply through the pressure reducer 38 flows first through the float valve 44 before passing through the injector 42.

In use, the operator first opens valve V to deliver a desired amount of water from the water supply 12 to the mixing tank 14 mixes a desired quantity of powdered cleaner with the water. In typical batch mixing operations, the desired concentration of the concentrated cleaning solution in the mixing tank can typically be obtained by opening the valve V until the water in the mixing tank 14 rises to a predetermined level, then shutting the valve V, introducing a corresponding predetermined amount of powdered chemical, and then stirring the contents using the stirrer 32 until the powder is substantially dissolved.

On the other hand, the proportional mixing apparatus 20 or 20A hereof provides an elegant and economical way to combine the concentrated cleaning solution mixed in the mixing tank 14 with water and an additional liquid detergent for on-demand delivery. Because the concentrated chemical solution is liquid and ready for further mixing, a premixed quantity of the concentrated chemical solution will last for a sufficient time such that on-demand mixing in the proportional mixing apparatus is possible. This may be accomplished without the need for pumps to deliver the liquid cleaner from the container 22 and the concentrated cleaning solution from the tank in accordance with the present invention.

Thus, in the present invention, the arrangement of the components allows the introduction of different cleaning compositions, and particularly concentrated cleaning solutions and liquid cleaning concentrates, in series for in-line mixing, and notwithstanding the existence of some backpressure at the point where the first of the cleaning compositions is introduced. The proportional mixing apparatus operates from the pressure and flow developed by the water supply, without requiring external power to draw the cleaning compositions into the flow stream, accomplishing the same in series, and without external power required to intermix the water and cleaning compositions.

By way of an example the proportional mixing apparatus 20 is connected to a municipal water supply having an inline pressure which is maintained in excess of 20 psi and thus the pressure reducer 38 maintains the pressure in the flowstream of the apparatus immediately downstream therefrom at 20 psi. An akaline cleaning composition such as trisodium phosphate (TSP), typically provided in powdered form, is mixed with water in a ratio of approximately 1 pound of alkaline cleaner per 1 gallon of water, and typically a 50 gallon batch of the first cleaning composition would be prepared. This mixture is stirred until substantially dissolved to provide the concentrated cleaning solution as a first cleaning composition in a batch method as outlined above. A concentrated liquid surfactant, such as a detergent, is provided as a second liquid cleaning composition in container 22 and connected by tube 56 to the injector 42. A metering orifice is selected for the injector 42 to deliver the concentrated liquid cleaning composition into the liquid flow at a maximum rate of 1000 parts water per part of surfactant by volume, but more preferably the supply of surfactant from the container 22 would be approximately between 300 and 50 parts water to 1 part surfactant and most preferably about 200 parts water to 1 part surfactant. The second concentrated liquid cleaning composition is preferably a surfactant, such as a detergent, is then mixed with the water in the liquid flow and delivered either after the float valve in the embodiment shown in FIGS. 3 and 4, or to pass through the float valve 44 before reaching the proportioner 46 in the embodiment shown in FIGS. 1 and 2. In either event, the second concentrated liquid cleaning composition, which is different from the first cleaning composition, is introduced into the flow path under pressure caused by the restriction of the venturi in the proportioner 46. A metering orifice for the proportioner is selected such that the first cleaning composition (preferably the dissolved powder alkaline concentrated cleaning solution) is then delivered into the liquid flow by the proportioner at a maximum rate of about 200 parts water per 1 part of the first cleaning composition by volume, but more typically will be introduced at a ratio of about 20 to about 10 parts water per 1 part of the first cleaning composition . The mixed liquid flow including the water from the main pipe 28, the first cleaning solution, and the second cleaning solution leave the proportioner at substantially atmospheric pressure and are delivered to the holding tank 16, ready for use. Of course, it is to be understood that the particular proportions of the cleaning compositions to each other or to the amount of water flowing through the proportional mixing apparatus 20 may be varied according to the intended use and specific formulations desired by selection of the desired metering orifice to provide the intended proportions of the first and second cleaning compositions in the final mixed composition. The foregoing is by way of illustration only as to the possibility of different proportions for the chemicals introduced through the venturi of the injector and proportioner. Beneficially, the use of a pressure regulator enables the delivery of the first and second cleaning compositions with a considerable degree of accuracy and avoids the variations in pressure normally expected from a water supply under pressure.

Although preferred forms of the invention have been described above, it is to be recognized that such disclosure is by way of illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of his invention as pertains to any apparatus not materially departing from but outside the literal scope of the invention as set out in the following claims:

1. A proportional mixing apparatus for mixing a plurality of different liquids into a liquid flow under pressure, said apparatus comprising:
a pressure reducer for fluidic connection to a water supply and for delivering water at a predetermined maximum pressure into the liquid flow;
a float-actuated control valve positioned downstream in the liquid flow from said pressure reducer, said float-actuated valve being connected to a float supported by liquid held in a tank, said float-actuated control valve being positioned in the liquid flow and operable for terminating the flow of liquid in the water flow in response to predetermined upward movement of the float;
a first venturi positioned in said liquid flow downstream of said float-actuated control valve and adapted for introducing a first liquid cleaning composition into the liquid flow, wherein said first venturi is positioned for delivery of liquid therefrom at substantially atmospheric pressure;
a first source for a first cleaning composition fluidically connected to said first venturi;
a second source for a second cleaning composition; and
a second venturi positioned in said liquid flow upstream of said first venturi and fluidically connected to said second source for delivering water mixed with a quantity of said second cleaning composition under pressure to said first venturi.

2. A proportional mixing apparatus as claimed in claim 1, including a check valve positioned between said second venturi and said second source for preventing flow from said liquid flow into said container.

3. A proportional mixing apparatus as claimed in claim 1, wherein said pressure reducer is a flow restrictor.

4. A proportional mixing apparatus as claimed in claim 1, wherein said pressure reducer is a pressure reducing valve.

5. A proportional mixing apparatus as claimed in claim 1, wherein said second venturi is positioned in said liquid flow upstream from said float-actuated control valve.

6. A proportional mixing apparatus as claimed in claim 1, wherein said second venturi is positioned in said liquid flow downstream from said float-actuated control valve.

7. A method of mixing first and second cleaning compositions into a liquid flow, said method comprising:
providing a source of water under pressure, a first source of a first concentrated cleaning solution, a second source of a second concentrated cleaning solution, a proportional mixing apparatus defining a flowpath therethrough and including a first venturi located in said flowpath fluidically connected to said first source and a second venturi located in said flowpath and fluidically connected to said second sources, and a holding tank;
flowing water under pressure through said flowpath of said proportional mixing apparatus and past said venturis, wherein said first venturi is positioned downstream from said second venturi in said proportional mixing apparatus;
drawing said first concentrated cleaning solution into said flowpath downstream from said second venturi to provide a pressure above atmospheric upstream from said first venturi;
drawing said second concentrated cleaning solution into said flowpath upstream from said first venturi; and
delivering the water mixed with said first and second concentrated cleaning solutions to said holding tank.

8. A method as set forth in claim 7, including the step of providing a float actuated control valve in said flowpath and acuating said float actuated control valve to terminate the flow of water in response to an increase in the liquid level in the holding tank.

9. A method as set forth in claim 8, wherein the float actuated control valve is positioned intermediate the first and second venturi and including the step of terminating the flow in said flowpath upstream from said first venturi.

10. A method as set forth in claim 9, wherein the float actuated control valve is positioned upstream from the first and second venturi and including the step of terminating the flow in said flowpath upstream from the second venturi.

11. A method as set forth in claim 7, including providing a pressure reducer, and including the step of reducing the pressure of the water delivered from the source of water under pressure prior to the water reaching the second venturi.
